(19) United States
(12) Patent Application Publication
(10) Pub. No.: US 2025/0249707 A1
(43) Pub. Date: Aug. 7, 2025

(54) VEHICULAR TIRE-TREAD SAFETY SYSTEM

(71) Applicant: Ross Blankenship100, Edwards, CO (US)

(72) Inventor: Ross Blankenship100, Edwards, CO (US)

(21) Appl. No.: 18/435,952

(22) Filed: Feb. 7, 2024

(51) Int. Cl. B60C 11/24

(52) U.S. Cl. CPC B60C 11/246

(57) ABSTRACT

The invention herein disclosed is vehicular tread depth safety system attached to each of a vehicle's wheel wells and automatically scanning and measuring tread depth on the uppermost portion of each tire in each wheel well. The smallest tread depth measured is compared to a predetermined minimum safety depth limit. If measured depth is below the predetermined limit, a system will invoke a tread-depth warning icon to be displayed on a vehicle's instrument display panel.

### TECHNICAL FIELD

The invention is a system that scans a tire surface to compute tread depth and issue a warning if tread depth is less than a predefined lower limit.

### BACKGROUND OF INVENTION

Vehicles move, turn and stop due to friction between a road surface and a tire surface. Vehicular safety depends in large part upon a vehicle's tires' coefficient of friction on a road surface. When new, a tire will have a tread pattern made up of ribs and grooves. The typical tread depth of a new tire is often greater than 11/32 inches. As tires are used to drive tens of thousands of miles, the surface will wear down making the tread depth less and less.

Experiments have shown that as tread depth gets smaller than 4/32 inches, the tire's ability to adhere to a road surface when turning or braking is diminished. As a result, stopping distances increase and the likelihood of skidding during a turn increases.

There are no federal standards for safe tread depth, but 42 states have traffic laws that establish 2/32 inches as the lower limit of safe tire operation.

There are rule-of-thumb tests for determining whether tread depth is below a safe limit. The so-called “penny test” has one placing a penny's edge against the bottom of a groove with Lincoln's head facing downward. If the rib surface does not reach the bottom of Lincoln's head, then most likely the tread depth is less than 2/32 inches.

Other devices have been made and sold that make determining tread depth more precise. However, what all of these have in common is having a person, outside the vehicle, moving from tire to tire and physically testing tread depth.

Some years ago, the same was true of tire inflation testing. One had to move from tire to tire, remove the valve stem cap, and press a tire-pressure gauge onto the valve stem while reading the measured pressure.

However, for several years, now, a valve stem/pressure sensor has been installed on each wheel which sends an essentially continuous reading of tire pressure via a wireless signal to a vehicle's instrument display. When a sensor detects a pressure below a predetermined value, it will invoke a warning “under inflation” icon on that display.

Currently, however, there is no analogous sensor that automatically measures tire tread depth against a predetermined value.

### BRIEF DESCRIPTION OF INVENTION

The invention herein disclosed and claimed is a tread depth safety system that is permanently installed at the highest point of a vehicle's wheel wells, and uses laser light distance measuring to precisely determine maximum and minimum beam length which can be used to directly calculate rib-to-groove length (i.e. tread depth). As with tire inflation sensors, the tread-depth safety system compares measured depth against a predetermined depth limit. Where it detects one or more tires having a tread depth smaller than that limit, it invokes a “tread depth safety warning” icon on the vehicle's instrument display panel.

### BRIEF DESCRIPTION OF DRAWINGS

FIG. 1 a cut-away view of a tire indicating the top surface of a rib and the bottom surface of a groove.

FIG. 2 illustrates how the tread depth safety system uses laser light to scan a vehicle's tire surface.

FIG. 3 illustrates an embodiment of the invention, mounted at the highest point inside a wheel well and aiming its beam essentially vertical to scan a tire's surface.

FIG. 4 illustrates an embodiment of the invention and its subsystems.

FIG. 5 illustrates the interconnection of the invention's subsystems.

FIG. 6 is a flow diagram showing an embodiment of method-of-use steps performed by the tread depth safety system.

### DETAILED DESCRIPTION OF INVENTION

For years, now, vehicular tire inflation pressure has been sensed and reported by in-wheel valve-stem sensors. When they detect a pressure that is below some predetermined limit, they invoke an “inflation warning” icon on a vehicle's instrument display. Because these sensors are contained inside the tire, they have self-contained power provided by a battery. There is no conductive power conveyance between these sensors and the vehicle's power source (e.g. its battery).

Until now, there has been no similar sensor installed as part of a vehicle's safety systems that measures and compares tire tread depth with predetermined minimum depth limits and similarly invokes a warning icon in the case of unsafe tread depth.

The invention is a vehicular tread depth safety system that is mounted to the highest part of a vehicle's wheel well and operative to scan the upper most part of a tire's surface using laser-based distance detection.

The invention's position in the wheel well is chosen such that if the front tires are not in line with the rear tires while parked, when the system is initiated, it will measure the uppermost part of the tire surface which will be essentially rotated horizontally with respect to the vertically focused beam but not out of line with the scanning laser. This will minimize any measurement corrective measures.

For a typical passenger vehicle, equipped with the safety system, there would be four sensors, one in each wheel well. When the vehicle is turned off, the system is powered down. When the ignition is first started, and the vehicles is not yet in motion, as with other vehicular sensors, they will quickly scan, measure and compare to see if tread depth is less than minimum. If so, like the tire-inflation sensors, the tread-depth sensors will invoke a warning icon to be displayed on the vehicle's instrument panel.

The vehicle's tread depth safety systems may be power self-contained using built-in battery power, or they may be wired, through wheel-well apertures, to a vehicle's power system.

Similarly, the tread depth safety systems could be wired to a vehicles display control system, or, like the tire-inflations sensors, invocation of a warning icon may be conveyed wirelessly rather than through conductive means.

When the ignition is first powered on, the scanning sequence is initiated. During that sequence, each tread depth safety system will transmit a succession of laser beams directly at the tire surface, receive its reflected beam, then repeat while moving laterally. The transmitted and reflected beams can be measured very precisely as to the complete round-trip distance. As the calculations are gathered, a control system in the tread depth safety system will process, under program control, the successive distance readings to determine a maximum distance (bottom of groove) and minimum distance (top of rib). The difference between those readings is the measured tread depth. The control system, under program control, will determine the smallest tread-depth value measured, and compare it to a predetermined minimum tread-depth value. If the measured value is more than the safe value, no further action is taken and the process ends. If the measured value is less than the safe value, before ending the process, that tread depth safety system control subsystem will convey a message to a wireless conveyance subsystem, or via a conductive path, to trigger the vehicle's instrument display to display a tread depth warning icon.

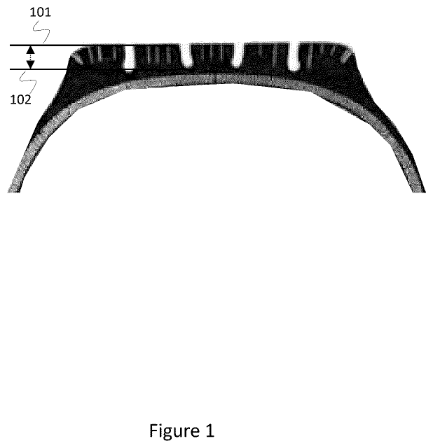

The following, in view of the drawings, is meant to provide more detail to this description. In FIG. 1, a cut-away view of a tire, 101 is the highest point of a rib whereas as 102 is lowest point of a groove. In essence, the displacement shown is the tread depth for that sample.

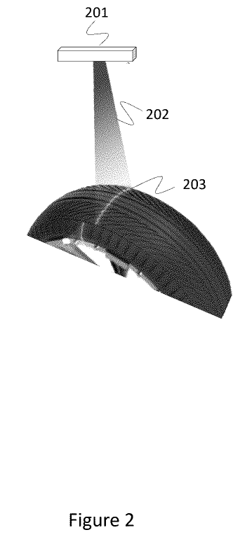

FIG. 2 shows an exemplary implementation of the invention (201) wherein the invention's laser light (202) is used to scan the tire's surface (203).

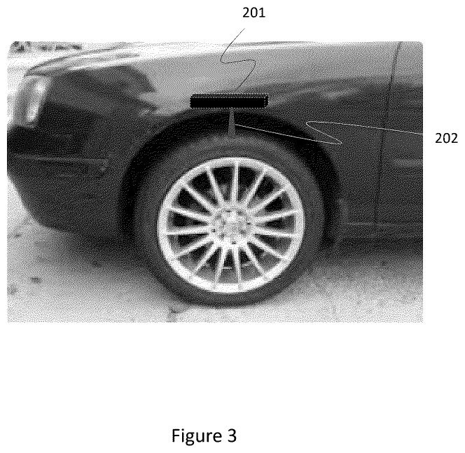

FIG. 3 shows the invention embodiment (201) in place in the uppermost part of the wheel well with the laser light (202) scanning the uppermost surface of the tire.

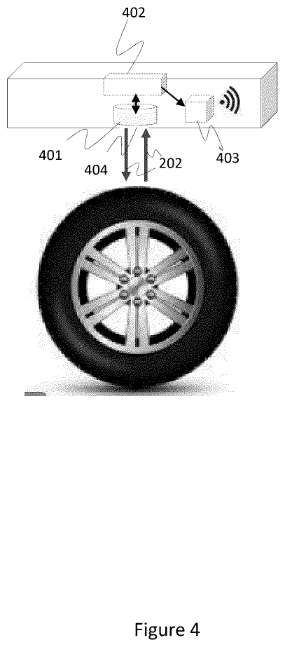

FIG. 4 shows the subsystems that comprise the invention embodiment. These are: a laser-based distance-measuring subsystem (401) positioned above an aperture (404) in its enclosure to allow transmitted and received light beams (202) to be directed essentially vertically upon the uppermost surface for the tire. The operation of the laser-based distance-measuring subsystem (401) is controlled by a control subsystem (402) comprising a microcontroller and at least one control program. Where necessary, to invoke a warning icon on a vehicle's instrument display panel, the control subsystem will convey an invocation message to a wireless-conveyance subsystem (403) which then transmits, wirelessly, that invocation message. In another embodiment wherein the invocation message is conveyed using conductive means, the wireless-conveyance subsystem would be unnecessary. The control subsystem would send the message via conductive means (not shown).

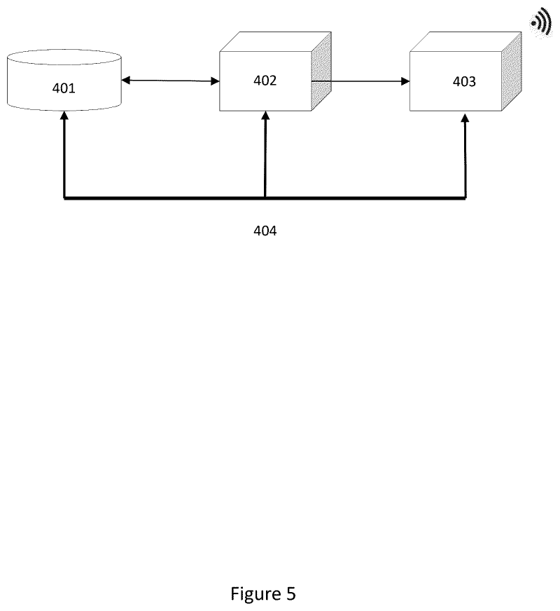

FIG. 5 shows the interconnection among the tread-depth safety system's subsystems. All subsystems receive power from a power bus (404) which may, in turn, receive power from a battery (not shown) or from the vehicle's power system (not shown) when ignition is initiated. The control subsystem (402) sends control data to the laser-based distance-measuring subsystem and receives measurement data from that subsystem. Where a warning invocation message is needed to indicate unsafe tread depth, the control subsystem (402) sends an invocation message to the wireless-conveyance subsystem (403). In all these cases, data and message conveyance is done using conductive means. Subsystem 403 will convey the invocation message wirelessly, as shown. Again, in an alternative embodiment, where the control subsystem conveys an invocation message directly to a vehicle's instrument display panel's control system, the message is conveyed via conductive means and subsystem 403 is not required.

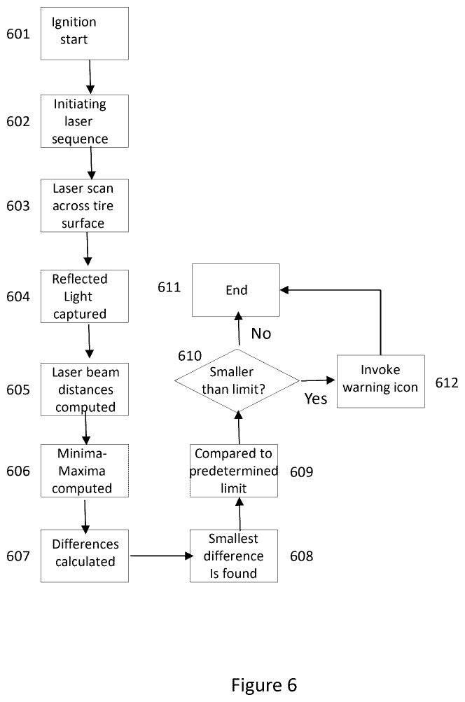

The following flow control diagram, FIG. 6, describes the method steps carried out by each of the tread depth safety systems installed in each of a vehicle's wheel wells. When ignition is started (601), the tread depth safety system's control subsystem initiates a laser scan sequence (602). The laser-based distance-measuring subsystem scans the surface of the tire (603) by transmitting and receiving the laser light, thereby capturing the reflected light (604). The laser-based distance-measuring subsystem uses the round-trip transmitted/reflected beam duration to compute the length traveled for each round trip (605). The round trips will differ as the beams move laterally and repeat the process. Using the distance data, the laser-distance-measuring subsystem computes maximum and minimum lengths (606), calculates the differences (607), and determines the smallest measured distance (608) which is equivalent to the minimum measured tread depth. Then, that minimum is compared to a predetermined tread depth safety limit (609). A conditional step follows where in the minimum measured tread depth is above the minimum limit (610) or below the limit. If above the limit, the process ends. If below the limit, an warning icon invocation message is sent (612), after which the process ends.

Because the tread depth safety systems are located inside the wheel well, they add no drag. They are also least exposed to water, mud and dust, but could have a protective cover over the aperture that opens upon ignition start and closes when the process ends, thus keeping the aperture and laser-distance-measuring subsystem clean.

The drawings and descriptions are meant to be exemplary should not be read as limiting the patent claim scope. The system could be located on the opposite side of the wheel well wall, inside the engine compartment, too, so long as it can carry out the process steps.

In the embodiment depicted in the drawings, the system could be added, after market, and integrated with a vehicle's other safety systems. The subsystems described herein are novel in the sense that they are incorporated in a safety system that is automatic and requires no person to move from tire to tire measuring tread depth.

The subsystems are shown as discreet modules but could be integrated into a monolithic embodiment.

Enclosure materials are not critical as long as they are durable enough to resist heat and damage inside the wheel well.

What is claimed is:

1. A vehicular tread-depth safety system comprising:
a laser-based distance-measuring subsystem;
a control subsystem; and
a wireless-data-conveyance subsystem.

2. A claim as in claim 1 wherein:
the laser-based distance-measuring subsystem is contained in an enclosure.

3. A claim as in claim 2 wherein:
the enclosure is firmly mounted on the uppermost portion of a vehicle's wheel well facing the uppermost portion of a tire tread surface.

4. A claim as in claim 3 wherein:
the enclosure's aperture is positioned and operative to support laser light beams impinging on a tire's uppermost tread surface and reflecting back to the enclosure's aperture.

5. A claim as in claim 1 wherein:
the control system is operative to control the operation of the laser-based distance-measuring subsystem; and
the control system is operative to control the operation of the wireless-data-conveyance subsystem.

6. A claim as in claim 1 wherein:
the laser-based distance-measuring subsystem receives and conveys control data from, and measurement data to, the control subsystem using conductive means, respectively.

7. A claim as in claim 1 wherein:
the control subsystem conveys an icon-invocation message to the wireless-data-conveyance subsystem using conductive means.

8. A claim as in claim 1 wherein:
the wireless-data-conveyance subsystem conveys icon-invocation data to the vehicle's instrument panel display subsystem using wireless means.

9. A vehicular tread-depth safety system comprising:
the laser-based distance-measuring subsystem; and
the control subsystem.

10. A claim as in claim 9 wherein:
the laser-based distance-measuring subsystem is contained in the enclosure.

11. A claim as in claim 9 wherein:
the enclosure is firmly mounted on the uppermost portion of a vehicle's wheel well facing the uppermost portion of a tire tread surface.

12. A claim as in claim 12 wherein:
the enclosure's aperture is positioned and operative to support laser light beams impinging on a tire's uppermost tread surface and reflecting back to the enclosure's aperture.

13. A claim as in claim 9 wherein:
the control system is operative to control the operation of the laser-based distance-measuring subsystem.

14. A claim as in claim 9 wherein:
the laser-based distance-measuring subsystem receives and conveys control data from, and measurement data to, the control subsystem using conductive means, respectively.

15. A claim as in claim 9 wherein:
the control subsystem conveys an icon-invocation message to the vehicle's instrument panel display subsystem using conductive means.

16. A method claim comprising:
initiating engine ignition;
instructing, by a control subsystem, a laser-based distance-measuring subsystem to begin a laser-scan sequence;
transmitting and receiving laser light to and from a tire's tread surface;
measuring the laser light beams' transmit-and-receive time durations;
using the time durations to calculate distance between laser-beam source and tire tread surface;
computing maximum and minimum distances;
subtracting minimum distances from maximum distances to calculate tread depth;
comparing tread-depth metrics to predetermined safety limit;
if metric is above the predetermined safety limit, then ending all operation;
if metric is at, or below, the predetermined safety limit, then invoking a warning icon display; and
ending all operation.
